(19) United States
(12) Patent Application Publication
(10) Pub. No.: US 2019/0129832 A1
(43) Pub. Date: May 2, 2019

(54) SYSTEM AND METHOD FOR TEST DATA GENERATION FOR USE IN MODEL BASED TESTING USING SOURCE CODE TEST ANNOTATIONS AND CONSTRAINT SOLVING

(71) Applicant: Siemens Aktiengesellschaft, Munich (DE)

(72) Inventors: Christof J. Budnik, Hamilton, NJ (US); Monica McKenna, North Berwick, ME (US)

(21) Appl. No.: 15/801,562

(22) Filed: Nov. 2, 2017

(51) Int. Cl. G06F 11/36; G06F 9/44; G06F 17/27; G06F 17/24

(52) U.S. Cl. CPC G06F 11/3684; G06F 11/3688; G06F 17/241; G06F 17/2705; G06F 8/35

(57) ABSTRACT

A system and method for automatically generating test data for a software application of a system under test includes inserting test annotations in source code of the software application. A code analyzer identifies and collects the test annotations in control flow order. At least some of the test annotations contain constraints relating to input data or conditions processed by the software application. The collected test annotations define an initial pre-Model Based Testing model which is provided to a constraint solver to provide a constraint solution based on the test annotations containing constraints. The constraint solution and the pre-MBT model is used to generate an expanded MBT model which defines specific use cases for a test suite of the system under test. A test is performed based on the specific use cases.

### TECHNICAL FIELD

This application relates to modeling of industrial systems. More particularly, this application relates to testing of models for industrial systems.

### BACKGROUND

When testing software that models and tests industrial systems, an essential consideration is the generating of use cases including corresponding categories of data that represent the test model. Categories of data are collections of choices that are relevant as input for specific use cases determined while developing the test model. This is a difficult and time consuming aspect of the testing process, particularly for systems using complex data. This process frequently requires skilled testers to review specifications and utilizing domain knowledge, and attempt to determine various data values and/or ranges that are valid for a given use case. Working from the overall specification, the testers must coordinate the proper data values to achieve a desired use case scenario. This test data is essential to successfully generate use cases and their associated test cases from models designed to simulate industrial systems, including their real-world implementations. Improved methods and systems for more efficient generating of test data are therefore desired.

### SUMMARY

A method of automatically generating test data for a software application supporting a system under test includes embedding test annotations in source code of the software application, parsing the source code to collect the test annotations, processing the collected test annotations to produce categories of data for testing the software application, and testing operation of the software application based on the categories of data produced from the test annotations. Additionally, constraints relating to relevant inputs to the software application and including constraints in at least one of the test annotations may be included in the test annotations. In an embodiment, the constraint defines a range of allowable data values for one or more inputs to the software application. An initial pre-model-based testing (pre-MBT) model based on the collected test annotations is built. According to an embodiment, the constraint defines a range of allowable data values for one or more inputs to the software application. At least one of the test annotations may contain a constraint of an input to the software application.

According to aspects of embodiments, at least one test annotation containing a constraint is provided to a constraint solver and a constraint solution (e.g., a set of values for associated variables that satisfy all constraints) is received from the constraint solver. An expanded MBT test model is generated based on the initial MBT test model and the constraint solution.

A plurality of data for exercising use cases based on the expanded MBT test model is created and the use cases are tested using the created data in a test software suite to test specific use cases with detailed input data.

A system for testing a software application in a system under test includes a first computer processor and a memory in communication with the first computer processor. A second computer processor executing instructions for running a code analyzer is in communication with the first computer processor. A third computer processor executing instructions for running a constraint solver is also in communication with the first computer processor. A fourth computer processor executing instructions for running a test suite of software applications for testing software applications of the system under test using an expanded MBT model generated by the first computer processor. A set of computer readable instruction are stored in the memory that when executed by the first computer processor, cause the first computer processor to: provide source code of the software application in the system under test to the code analyzer, the source code containing test annotations; receive a list of test annotations; construct an initial pre-model based testing (pre-MBT) model based on the list of test annotations; provide the initial pre-MBT model to a constraint solver; receive a constraint solution from the constraint solver; and generate an expanded MBT model based on the constraint solution. At least one test annotation may define a constraint of a data input to the software application. The constraint may define a range of allowable data values for one or more inputs of the software application.

According to an embodiment, the memory contains instructions that when executed by the first computer processor, cause the first computer processor to generate an expanded MBT test model based on the initial pre-MBT test model and the constraint solution. In other embodiments, the memory contains instructions, which when executed by the first computer processor, cause the first computer processor to generate a plurality of use cases based on the expanded MBT test model.

In another embodiment the memory contains instructions, which when executed by the first computer processor, cause the first computer processor to run the plurality of use cases in a software sure to test specific use cases with detailed input data. According to aspects of an embodiment, the test annotations are inserted into the source code by a developer at development. The software application may be a plurality of software procedures arranged in a control order and the list of test annotations is received in control flow order. According to aspects of some embodiments, the constraint may define a condition which is analyzed by the software application.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagram of a model-based testing (MBT) system according to aspects of embodiments of the disclosure.

FIG. 2 is a block diagram of test data generation for a model-based industrial system according to aspects of embodiments of the disclosure.

FIG. 3 is a process flow diagram of a method for preprocessing an expanded MBT model for a model-based system for evaluating an industrial system according to aspects of embodiments of the disclosure.

FIG. 4 is a block diagram of a computer system for implementing test data generation systems for model-based evaluation of industrial system according to embodiments of the disclosure.

### DETAILED DESCRIPTION

In developing test cases for model-based systems or other systems containing sufficient artifacts that may be represented in a model, users typically enter test data in model-based testing tools. This test data is generated, at least in part, by the user's knowledge of the test domain. Data categories may be derived by reviewing the specifications of the underlying system being modeled. Understanding the specification, along with users' past experiences in selecting effective test cases, as well as knowledge of specific situations in which errors are likely to occur, drive the choices made to generate robust testing data values.

Model-based systems are heavily reliant on software for their execution. Software is developed by developers who, given a specification for an underlying system, develop source code in a development language of choice, which interacts with modules or components of the underlying system, or in the case of modeling, software modules that simulate those components of the underlying system. Characteristics of the components of the system, as well as other system parameters may be simulated in model-based software. By way of non-limiting example, ambient temperatures, or interactions between various components may be simulated in addition to states of the components themselves.

Some test systems have attempted to solve the problem of generating effective test cases and test data by manually selecting data intended to reach specific portions of the underlying source code. For example, if portion of source code is intended to generate an alarm when a temperature in a portion of the system reaches 100° Celsius, the source code would be programmed to compare a variable value to the alarm threshold and generate a resulting value or variable that is indicative of an alarm condition or non-alarm condition. With knowledge of the underlying source code, a series of test cases may be generated that include a temperature value that is below the alarm threshold, a temperature value that is exactly at the alarm threshold, and a value that exceeds the alarm threshold. However, conventional systems that target only single procedures within the source code are not scalable for large systems due to unsupported code constructs.

According to embodiments described in this disclosure, a guided test system is provided that generates input data for model based tests. Once initial data constraints are provided by the developer/tester, a system according to aspects of the embodiments is fully automatic through testing generation. A testing system may be adapted to parse source code to detect test annotations embedded in the source code to build an initial pre-MBT model including constraints.

A constraint solver is then used to determine appropriate data ranges and values allowed for the test data. The constraint solution is used with the pre-MBT model to derive an expanded MBT test model which may be used to test the system.

Developers or testers may enter specific annotations, including but not limited to, data types, default data values, and data ranges that are inserted into the source code during development. The annotations may relate to constraints on the data relating to the methods that the developer is currently coding and may include the relevant use case required to reach a specific location within the source code and provide ranges of data that are appropriate for the relevant use case. A program may be configured to use an open source code analyzer that parses the source code to find the specialized annotations. A second program may be called upon to take the parsed control flow information and annotations and produce an initial MBT model with stereotyped notes. The initial MBT model is run through the test generation process, including a pre-generation step that uses the stereotyped notes and use case information to create input for a general constraint solver to generate constraint solutions. The resulting constraint solutions specify data values and ranges, which are used to generate categories and data value choices specific to given use cases. The result is an expanded MBT model that may be used to generate tests that have appropriate valid data values to reach and exercise intended use cases under test via their associated computer code.

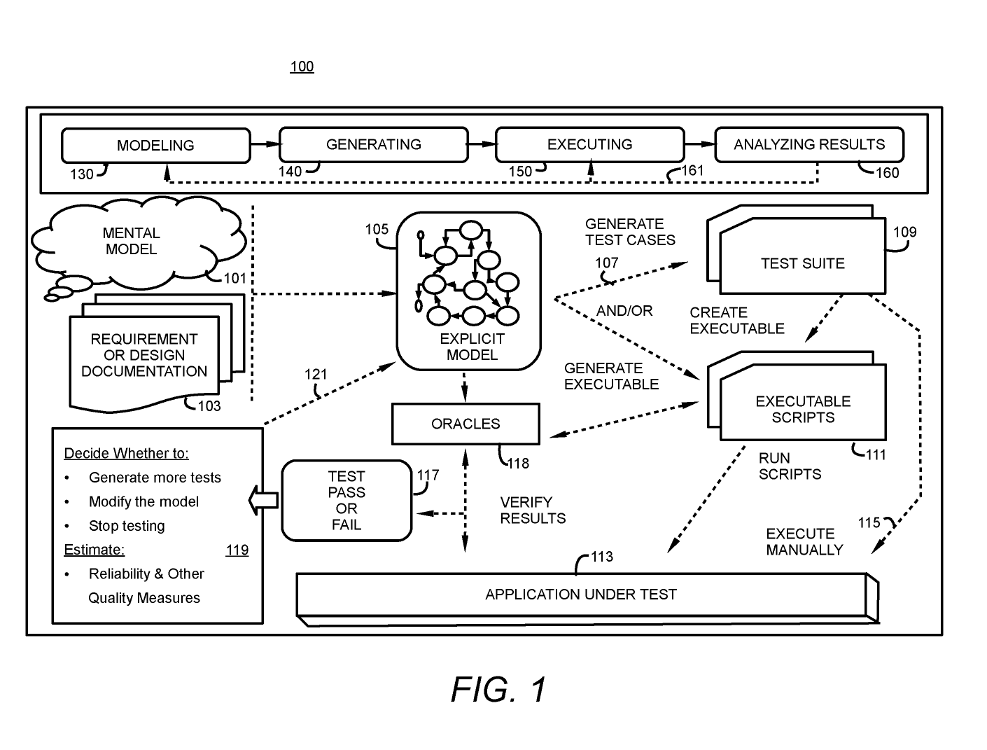

FIG. 1 is a block diagram of an MBT system 100 according to aspects of embodiments of this disclosure. A user conceives a mental model 101 of the system she derives from a list of requirements or other design documentation 103. From the mental model 101 and documentation 103, an explicit model 105 is derived. From the explicit model 105, one or more test cases are generated 107 and provided to a test suite 109 of applications. Alternatively, or in addition to test suite 109, executable scripts 111, may be generated directly from the explicit model 105. In some embodiments, test suite 109 creates executable code reflected in executable scripts 111. In alternative embodiments the test suite 109 may be manually executed 115 in the application under test 113.

The executable scripts 111 may be run against computer code contained within an application under test 113. After running the use cases and their associated test cases in the application under test 113, outputs generated by the application under test 113 are analyzed by a computing system 118 to determine if the test case results in a pass or fail condition 117. Based on the test pass or fail condition 117, a decision is made whether to generate more test cases 107, modify 121 the model 105 or stop testing. This may be determined at least in part by estimating reliability and other quality metrics 119.

At a high level MBT system 100 operates by generating a model 130, generating test cases 140, executing the generated test cases 150 and analyzing results 160. Analysis provides feedback 161 to generate new test cases or modifying the model of the system or application under test.

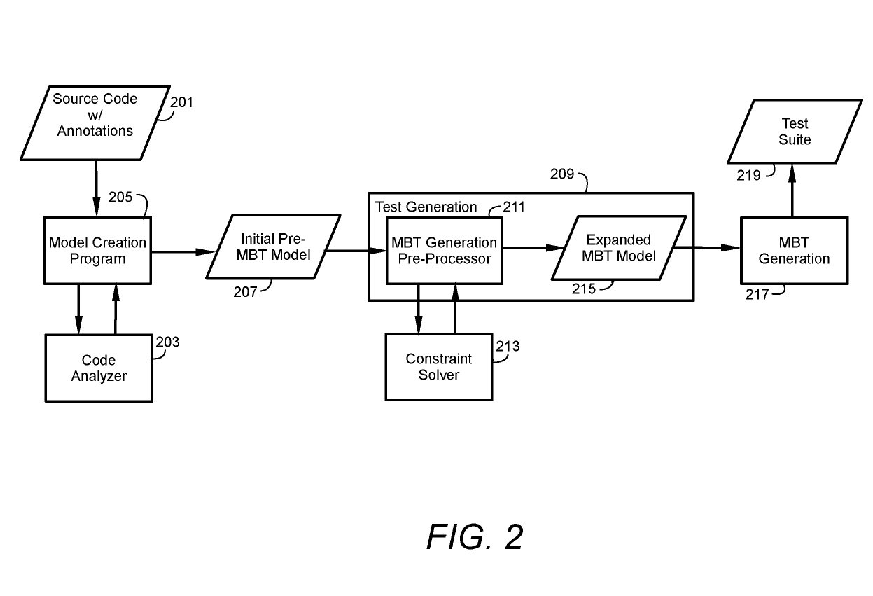

FIG. 2 is a block diagram of a system and method for generating test data in a MBT system according to aspects of embodiments of the disclosure. The method begins when a developer enters specific annotations into the source code during development to produce source code with annotations 201. The notations may denote specific data types, values and/or ranges for data relating to a given test case, by way of example. The source code with annotations 201 is provided to a model creation program 205 which is in communication with a code analyzer 203. The code analyzer 203 parses the source code to find test annotations and collects the annotations in control flow order for each flow in the source code that contains annotations. The model creation program 205 receives the source code with annotations 201 and provides the source code with annotations 201 to the code analyzer 203. The code analyzer 203 parses the source code and provides the model creation program 305 with the collected annotations in control flow order. The model creation program 305 then uses the collected annotations to create the initial pre-MBT model 207. The initial pre-MBT model 207 contains use cases, activity diagrams, and stereotyped notes based on the source code test annotations.

The test generator 209 includes the MBT Generation pre-processor 211, which is in communication with a constraint solver 213. Test generator 209 may be implemented as a stand-alone component, or may be implemented in a computer processor in communication with a memory storing instructions for execution by the processor to perform the processes and functions of a test generator 209. The constraint solver 213 receives the analysis results of the MBT generation pre-processor 211 and the stereotyped notes to produce a constraint solution. The constraint solver 213 is adapted to solve not only for a specific answer, but to generate a set and/or range of values that meet the constraint criteria. The constraint solution is returned to the MBT generation pre-processor 211. The MBT generation pre-processor takes the constraint solution using specific values specified in the solution and randomly selects values from sets and ranges of the solution. This processing creates categories and choice options represented by data for exercising specific use cases. The MBT generation pre-processor 211 adds a note to invoke the determined category for a specific use case.

The MBT generation pre-processor then generates the expanded MBT model 215 including categories and choices for each use case, along with notes to invoke the categories for each use case. The completed expanded MBT model 215 is then ready for test generation. The expanded MBT model 215 is provided to the MBT generation block 217. MBT generation 215 generates test cases from the MBT model including data categories and data choices which meet the criteria provided to the constraint solver 213. The output of the MBT generation 217 is provided to test suite 219 of programs which run tests of the MBT model testing specific use cases using detailed data generated during the test generation 209 process.

Embodiments according to the present invention allow for developer test input to be captured without additional tester effort. During development of source code, developers are in the best position to understand the source code implementation of the underlying specification. As a result, test data may be generated that tests the execution of code in particular areas where testing is desired and accurately reflects logic and operations that the developer intended to implement. Using constraints, the annotated source code provides improvements in test data generation in the elimination of invalid and/or inappropriate data from testing procedures.

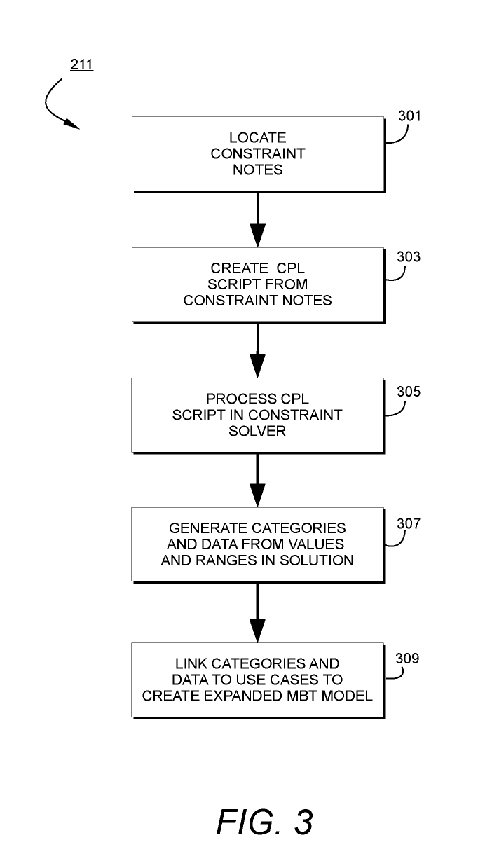

FIG. 3 is a process flow diagram of a method for pre-processing an MBT model according to aspects of embodiments of the disclosure. During the pre-processing step 211, constraint notes included in source code annotations are located 301. A constraint processing language (CPL) script is generated from the constraint notes in the annotations 303. The generated CPL script is provided to a constraint solver and the constraint solver processes the script 305 to produce a constraint solution. Categories and data choices are defined based on the values and ranges in the constraint solution 307. The categories and data choices are linked to use cases to generate an expanded MBT model 309. According to embodiments, the categories and data choices may be linked to use cases using a note in a test develop environment using the unified modeling language (TDE/UML) note. In other embodiments other methods of linking categories and data choices to use cases may be used.

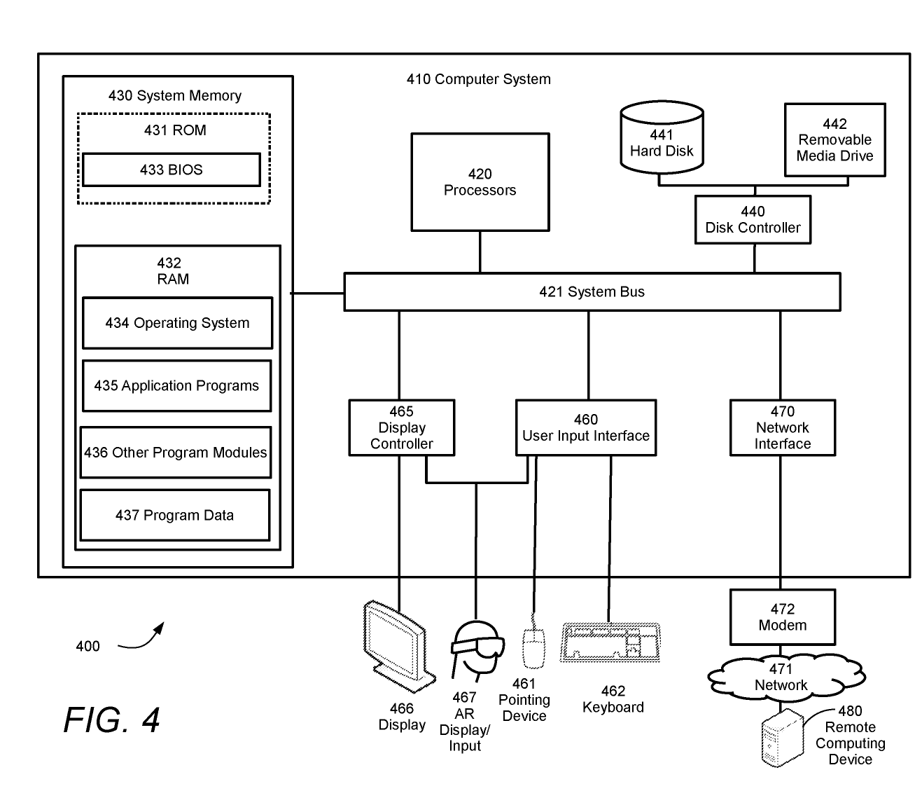

FIG. 4 illustrates an exemplary computing environment 400 within which embodiments of the invention may be implemented. Computers and computing environments, such as computer system 410 and computing environment 400, are known to those of skill in the art and thus are described briefly here.

As shown in FIG. 4, the computer system 410 may include a communication mechanism such as a system bus 421 or other communication mechanism for communicating information within the computer system 410. The computer system 410 further includes one or more processors 420 coupled with the system bus 421 for processing the information.

The processors 420 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 4, the computer system 410 also includes a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, other program modules 436 and program data 437.

The computer system 410 also includes a disk controller 440 coupled to the system bus 421 to control one or more storage devices for storing information and instructions, such as a magnetic hard disk 441 and a removable media drive 442 (e.g., floppy disk drive, compact disc drive, tape drive, and/or solid state drive). Storage devices may be added to the computer system 410 using an appropriate device interface (e.g., a small computer system interface (SCSI), integrated device electronics (IDE), Universal Serial Bus (USB), or FireWire).

The computer system 410 may also include a display controller 465 coupled to the system bus 421 to control a display or monitor 466, such as a cathode ray tube (CRT) or liquid crystal display (LCD), for displaying information to a computer user. The computer system includes an input interface 460 and one or more input devices, such as a keyboard 462 and a pointing device 461, for interacting with a computer user and providing information to the processors 420. The pointing device 461, for example, may be a mouse, a light pen, a trackball, or a pointing stick for communicating direction information and command selections to the processors 420 and for controlling cursor movement on the display 466. The display 466 may provide a touch screen interface which allows input to supplement or replace the communication of direction information and command selections by the pointing device 461. In some embodiments, an augmented reality device 467 that is wearable by a user, may provide input/output functionality allowing a user to interact with both a physical and virtual world. The augmented reality device 467 is in communication with the display controller 465 and the user input interface 460 allowing a user to interact with virtual items generated in the augmented reality device 467 by the display controller 465. The user may also provide gestures that are detected by the augmented reality device 467 and transmitted to the user input interface 460 as input signals.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium, such as a magnetic hard disk 441 or a removable media drive 442. The magnetic hard disk 441 may contain one or more data stores and data files used by embodiments of the present invention. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

The computing environment 400 may further include the computer system 410 operating in a networked environment using logical connections to one or more remote computers, such as remote computing device 480. Remote computing device 480 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A method of automatically generating test data for a software application supporting a system under test, the method comprising:
embedding test annotations in source code of the software application;
parsing the source code to collect the test annotations;
processing the collected test annotations to produce categories of data for testing the software application;
processing the categories of data in a model based testing generation pre-processor to randomly select values from sets or ranges contained in the categories of data; and
testing operation of the software application based on the randomly selected values from the categories of data produced from the test annotations.

2. The method of claim 1, further comprising:
defining constraints relating to relevant inputs to the software application and including constraints in at least one of the test annotations.

3. The method of claim 2, wherein the constraint defines a range of allowable data values for one or more inputs to the software application.

4. The method of claim 1, further comprising:
building an initial model-based testing model based on the collected test annotations.

5. The method of claim 4, wherein the constraint defines a range of allowable data values for one or more inputs to the software application.

6. The method of claim 4, further comprising:
embedding at least one test annotation containing a constraint of an input to the software application.

7. The method of claim 6, further comprising:
providing at least one test annotation containing a constraint to a constraint solver; and
receiving a constraint solution from the constraint solver.

8. The method of claim 7, further comprising:
generating an expanded MBT model based on the initial MBT model and the constraint solution.

9. The method of claim 8, further comprising:
generating a plurality of data for exercising use cases based on the expanded MBT model.

10. The method of claim 9, further comprising
running a test of the plurality of data for exercising use cases in a test software suite to test specific use cases with detailed input data.

11. A system for testing a software application in a system under test comprising:
a first computer processor;
a memory in communication with the first computer processor;
a second computer processor executing instructions for running a code analyzer in communication with the first computer processor;
third computer processor executing instructions for running a constraint solver;
a model based testing (MBT) generation pre-processor configured to receive a solution from the constraint solver containing categories of data and randomly select values from sets and ranges contained in the categories of data; and
a fourth computer processor executing instruction for running a test suite of software applications for testing software applications of the system under test using the randomly selected values.

12. The system of claim 11, further comprising:
a set of computer readable instruction stored in the memory that when executed by the first computer processor, cause the first computer processor to:
provide source code of the software application in the system under test to the code analyzer, the source code containing test annotations;
receive a list of test annotations;
construct an initial pre-model based testing (pre-MBT) model based on the list of test annotations;
provide the initial pre-MBT model to a constraint solver;
receive a constraint solution from the constraint solver; and
generate an expanded MBT model based on the constraint solution.

13. The system of claim 12, wherein at least one test annotation defines a constraint of a data input to the software application.

14. The system of claim 13, wherein the constraint defines a range of allowable data values for one or more inputs of the software application.

15. The system of claim 12, wherein the memory contains instructions, which when executed by the first computer processor, cause the first computer processor to:
generate an expanded MBT test model based on the initial pre-MBT test model and the constraint solution.

16. The system of claim 15, wherein the memory contains instructions, which when executed by the first computer processor, cause the first computer processor to:
generate a plurality of use cases based on the expanded MBT test model.

17. The system of claim 16, wherein the memory contains instructions, which when executed by the first computer processor, cause the first computer processor to:
run the plurality of use cases in a software sure to test specific use cases with detailed input data.

18. The system of claim 12, wherein the test annotations are inserted into the source code by a developer at development.

19. The system of claim 12, wherein the software application is a plurality of software procedures arranged in a control order and the list of test annotations is received in control flow order.

20. The system of claim 13, wherein the constraint defines a condition which is analyzed by the software application.
